(19) United States
(12) Patent Application Publication
(10) Pub. No.: US 2023/0350224 A1
(43) Pub. Date: Nov. 2, 2023

(54) METHOD AND APPARATUS FOR REMOVABLE MAGNETIC NOSE BRIDGE

(71) Applicant: Dell Products, LP, Round Rock, TX (US)

(72) Inventors: Loo Shing Tan, Singapore (SG); Michiel Sebastiaan Emanuel Petrus Knoppert, Amsterdam (NL); Thomas Marcus Hinskens, Utrecht (NL); Gerald Rene Pelissier, Mendham, NJ (US); Martin Douglas Sawtell, Singapore (SG)

(73) Assignee: Dell Products, LP, Round Rock, TX (US)

(21) Appl. No.: 17/732,186

(22) Filed: Apr. 28, 2022

(51) Int. Cl. G02C 5/04; G02B 27/01

(52) U.S. Cl. CPC G02C 5/04; G02B 27/0176; G02C 2200/02; G02C 2200/22

(57) ABSTRACT

An extended reality (XR) head-mounted display (HMD) device may include a processor; a memory device; a power management unit; an HMD video display to present to a user an extended reality image of an environment; an HMD housing fitted to be formed around a user's eyes; and a swappable nose bridge, including: a nose bridge extension to fit within a nose bridge slot formed into the HMD housing; and a nose bridge magnet formed at the nose bridge extension to magnetically engage within the nose bridge slot formed in the HMD housing.

### FIELD OF THE DISCLOSURE

The present disclosure generally relates to a head mounted display (HMD) device. The present disclosure more specifically relates to an HMD device including a removeable magnetic nose bridge.

### BACKGROUND

As the value and use of information continues to increase, individuals and businesses seek additional ways to process and store information. One option available to clients is information handling systems. An information handling system generally processes, compiles, stores, and/or communicates information or data for business, personal, or other purposes thereby allowing clients to take advantage of the value of the information. Because technology and information handling needs and requirements vary between different clients or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific client or specific use, such as e-commerce, financial transaction processing, airline reservations, enterprise data storage, or global communications. In addition, information handling systems may include a variety of hardware and software components that may be configured to process, store, and communicate information and may include one or more computer systems, data storage systems, and networking systems. The information handling system may include telecommunication, network communication, and video communication capabilities. Further, the information handling system may be operatively coupled to an extended reality (XR) device such as a head mounted display (HMD) device that allows a user to view a simulated XR environment.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system with a head mounted display (HMD) device having a swappable nose bridge according to an embodiment of the present disclosure;

FIG. 2 is a graphic diagram perspective view of an HMD device according to an embodiment of the present disclosure;

FIG. 3 is a graphic diagram side, sectional view of an HMD device and with a swappable nose bridge according to an embodiment of the present disclosure;

FIG. 4 is a graphic diagram perspective view of a swappable nose bridge of an XR HMD device according to an embodiment of the present disclosure;

FIG. 5 is a graphic diagram bottom view of an XR HMD device with a plurality of different sized swappable nose bridges according to another embodiment of the present disclosure; and

FIG. 6 is a flow diagram of a method of manufacturing an HMD device with a swappable nose bridge according to an embodiment of the present disclosure.

The use of the same reference symbols in different drawings may indicate similar or identical items.

### DETAILED DESCRIPTION OF THE DRAWINGS

The following description in combination with the Figures is provided to assist in understanding the teachings disclosed herein. The description is focused on specific implementations and embodiments of the teachings, and is provided to assist in describing the teachings. This focus should not be interpreted as a limitation on the scope or applicability of the teachings.

Head mounted display (HMD) devices may be wearable around the user's head and/or eyes and have the capability of providing displayed or projected images to a user. In an example, a user may be provided with a completely virtual reality (VR) environment while using the HMD device. In another example, the HMD devices may allow the user to see through those displayed or projected images in, for example, augmented reality (AR) or mixed reality (MR). Indeed, HMD devices may be capable of generating any type of extended reality (XR) environment such as AR, VR, MR, or any other type of XR environment provided by the HMD device and contemplated to exist along a reality-virtuality continuum.

HMD devices may be used for a variety of tasks and purposes. For example, HMD devices may be used to engage in video games, videoconferences, distance learning, virtual manufacturing, immersive training, and simulation, three-dimensional (3D) visualization and review, guided or remote assist applications, and other tasks or processes that can be done virtually. During these tasks, the user may use the HMD device for an extended period of time and may need to be as comfortable as possible when wearing the HMD device.

The present specification describes an extended reality (XR) head-mounted display (HMD) device that includes a processor, a memory device, a power management unit, and an HMD video display to present to a user an extended reality image of an environment. The HMD device further includes an HMD housing formed to be fitted around a user's eyes. In order to provide a level of comfort to the user, the HMD device may include a swappable nose bridge. The swappable nose bridge includes a nose bridge extension to fit within a nose bridge slot formed into the HMD housing in embodiments of the present disclosure. A nose bridge magnet is disposed at the nose bridge extension to magnetically engage within the nose bridge slot formed in the HMD housing in an embodiment.

In an embodiment, the nose bridge extension is sized to create a removable interference fit within the nose bridge slot formed into the housing of the HMD device. This may add an additional level of fitting of the swappable nose bridge into the nose bridge slot in addition to or instead of the nose bridge magnet. In an embodiment, the nose bridge slot may have a metal keep that magnetically interfaces with the nose bridge magnet to magnetically secure the nose bridge extension of the swappable nose bridge to the housing of the HMD device. Additionally, or alternatively, the nose bridge slot may have a slot magnet formed into the nose bridge slot, the slot magnet to magnetically engage with the nose bridge magnet and having opposite polarity.

In an embodiment, the swappable nose bridge includes a nose bridge collar formed on the swappable nose bridge to conform to a surface of the HMD housing to keep the HMD housing lightproof. Because the user may be viewing an image provided to the user via an HMD display of the HMD device, external light may inhibit the user's ability to discern the images and video presented to the user via this HMD display. The nose bridge collar may prevent this light leakage and provide a lightproof environment. It is understood that the HMD nosebridge is designed to restrict or limit light leaking into the HMD hood when the HMD device is worn by the user for improved viewing of XR images and XR environment in embodiments herein. For purposes herein, the prevention or limitation on light entering the HMD hood is referred to as lightproofing or making nearly lightproof although some light may leak in in some circumstances.

In an embodiment, the swappable nose bridge may be formed to fit against a user's face and the user's nose. The swappable nose bridge, in an embodiment, may include one or more nose bridge slits formed into the nose bridge where the user's nose is to rest. The one or more nose bridge slits form nose bridge flaps use to cause the swappable nose bridge to conform to a surface of the user's nose. To add additional comfort to the user, the swappable nose bridge may include a shape memory alloy structure such as a sheet, wire, or rod embedded in the nose bridge to allow a portion of the nose bridge contacting the user's nose to be elastically deformed or manipulated to conform to a shape of the user's nose. The portion of the swappable nose bridge where the shape memory alloy structure is embedded into may include the nose bridge flaps.

The method of forming the swappable nose bridge may include injection molding processes. For example, nose bridge magnet may be placed within a mold and the material used to form the swappable nose bridge may be injection molded into the mold. In an embodiment, the nose bridge magnet may be formed into the nose bridge extension via this injection molding process. The material that the swappable nose bridge is made of may include a plastic or a rubber among other pliable materials.

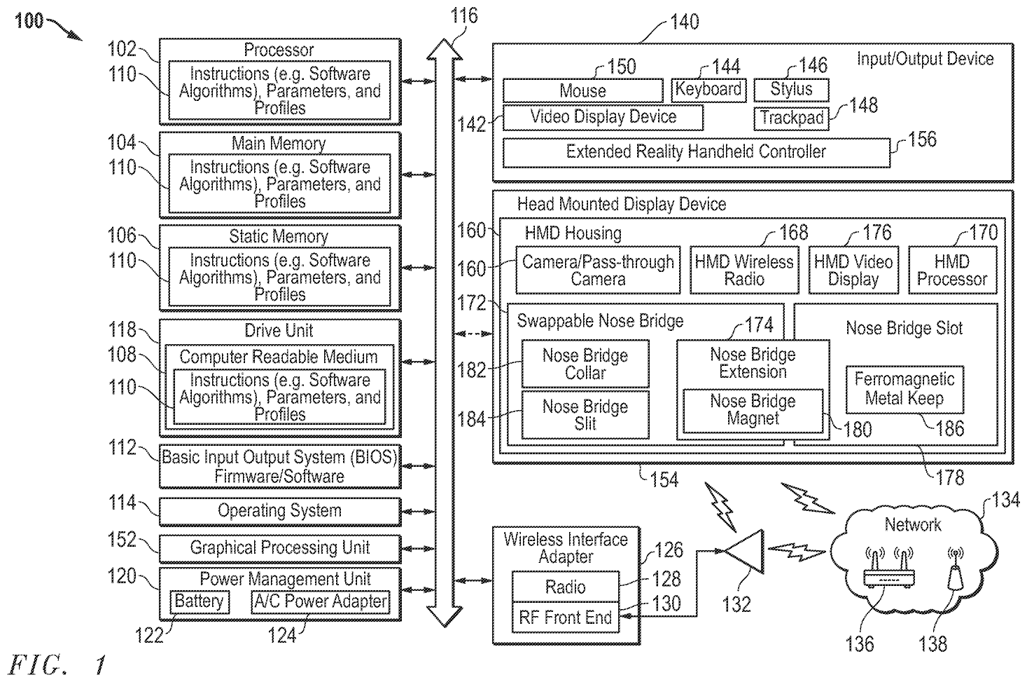

FIG. 1 illustrates an information handling system 100 similar to information handling systems according to several aspects of the present disclosure. In the embodiments described herein, an information handling system 100 includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system 100 can be a personal computer, mobile device (e.g., personal digital assistant (PDA) or smart phone), server (e.g., blade server or rack server), a consumer electronic device, a network server or storage device, a network router, switch, or bridge, wireless router, or other network communication device, a network connected device (cellular telephone, tablet device, etc.), IoT computing device, wearable computing device, a set-top box (STB), a mobile information handling system, a palmtop computer, a laptop computer, a convertible laptop, a tablet, a smartphone, a desktop computer, a communications device, an access point (AP), a base station transceiver, a wireless telephone, a land-line telephone, a control system, a camera, a scanner, a facsimile machine, a printer, a personal trusted device, a web appliance, or any other suitable machine capable of executing a set of instructions (sequential or otherwise) that specify actions to be taken by that machine, and can vary in size, shape, performance, price, and functionality.

In a networked deployment, the information handling system 100 may operate in the capacity of a server or as a client computer in a server-client network environment, or as a peer computer system in a peer-to-peer (or distributed) network environment. In a particular embodiment, the computer system 100 can be implemented using electronic devices that provide voice, video, or data communication. For example, an information handling system 100 may be any mobile or other computing device capable of executing a set of instructions (sequential or otherwise) that specify actions to be taken by that machine. In an embodiment, the information handling system 100 may be operatively coupled to a server or other network device as well as with an HMD device 154 and provide data storage resources, processing resources, and/or communication resources to the HMD device 154 as described herein. Further, while a single information handling system 100 is illustrated, the term “system” shall also be taken to include any collection of systems or sub-systems that individually or jointly execute a set, or multiple sets, of instructions to perform one or more computer functions.

The information handling system 100 may include memory (volatile (e.g., random-access memory, etc.), nonvolatile (read-only memory, flash memory etc.) or any combination thereof), one or more processing resources, such as a central processing unit (CPU), a graphics processing unit (GPU), processing, hardware, controller, or any combination thereof. Additional components of the information handling system 100 can include one or more storage devices, one or more communications ports for communicating with external devices, as well as, various input and output (I/O) devices 140, such as a keyboard 144, a mouse 150, a video display device 142, a stylus 146, a trackpad 148, and an XR handheld controller 156, or any combination thereof. The information handling system 100 can also include one or more buses 116 operable to transmit data communications between the various hardware components described herein. Portions of an information handling system 100 may themselves be considered information handling systems and some or all of which may be wireless.

Information handling system 100 can include devices or modules that embody one or more of the devices or execute instructions for the one or more systems and modules described above, and operates to perform one or more of the methods described above. The information handling system 100 may execute code instructions 110 via processing resources that may operate on servers or systems, remote data centers, or on-box in individual client information handling systems according to various embodiments herein. In some embodiments, it is understood any or all portions of code instructions 110 may operate on a plurality of information handling systems 100.

The information handling system 100 and HMD device 154 may include processing resources such as a processor 102 such as a central processing unit (CPU), accelerated processing unit (APU), a neural processing unit (NPU), a vision processing unit (VPU), an embedded controller (EC), a digital signal processor (DSP), a GPU 152, a microcontroller, or any other type of processing device that executes code instructions to perform the processes described herein. Any of the processing resources may operate to execute code that is either firmware or software code. Moreover, the information handling system 100 can include memory such as main memory 104, static memory 106, computer readable medium 108 storing instructions 110 of, in an example embodiment, an HMD application or other computer executable program code, and drive unit 118 (volatile (e.g., random-access memory, etc.), nonvolatile (read-only memory, flash memory etc.) or any combination thereof).

As shown, the information handling system 100 may further include a video display device 142. The video display device 142, in an embodiment, may function as a liquid crystal display (LCD), an organic light emitting diode (OLED), a flat panel display, or a solid-state display. Although FIG. 1 shows a single video display device 142, the present specification contemplates that multiple video display devices 142 may be used with the information handling system to facilitate an extended desktop scenario, for example. Additionally, the information handling system 100 may include one or more input/output devices 140 including an alpha numeric input device such as a keyboard 144 and/or a cursor control device, such as a mouse 150, touchpad/trackpad 148, a stylus 146, a XR handheld controller 156, or a gesture or touch screen input device associated with the video display device 142 that allow a user to interact with the images, windows, and applications presented to the user. In an embodiment, the video display device 142 may provide output to a user that includes, for example, one or more windows describing one or more instances of applications being executed by the processor 102 of the information handling system. In this example embodiment, a window may be presented to the user that provides a GUI representing the execution of a word processing application, a GUI representing the execution of a spreadsheet application, a GUI representing the execution of a computer-aided design application, a GUI representing the execution of a gaming application, a GUI representing the execution of an email application, and a GUI representing the execution of a web browsing application, an image generation application such as presentation software, or a drawing program, among others. In an embodiment, each of these windows may be represented on the HMD video display 176 of the HMD device 154 when the HMD device 154 is being used by the user. The presentation of these windows on the HMD video display 176 may be accomplished via execution of an application programming interface (API) in coordination with the HMD processor 170. In an embodiment, the information handling system 100 may include one or more APIs that allow the information handling system 100 to cause certain applications to be executed on the HMD device 154. These APIs may be associated with one or more sets of instructions (e.g., software algorithms), parameters, and profiles 110 that, during execution of an XR environment at the HMD device 154, causes these applications to be represented to the user within the XR environment. For example, a gaming application being executed by the processor 102 of the information handling system 100 may include an API that, when the HMD device 154 is being used by the user, allows that application to be executed at the HMD device 154 with the user being allowed to interact with the gaming application and maintain updates to changes made in the XR environment. It is appreciated that other types of applications may also be associated with APIs that allow those applications to be reproduced in an XR environment at the HMD device 154 including word processing applications, drawing applications, videoconferencing applications, among others.

In an embodiment, the information handling system 100 may be local to the user who may operate the HMD device 154. The information handling system 100 and/or HMD device 154 are operatively coupled to a network 134 via a wireless interface adapter 126 or a wireless interface adapter within the HMD device 154 via an HMD wireless radio 168, respectively. In an embodiment, the HMD device 154 and XR handheld controller 156 may be operatively coupled to one another and, optionally, to the information handling system 100 either via a wired or wireless connection such as Bluetooth or other protocol as described herein.

The network interface device of the information handling system 100 shown as wireless interface adapter 126 can provide connectivity among devices such as with Bluetooth or to a network 134, e.g., a wide area network (WAN), a local area network (LAN), wireless local area network (WLAN), a wireless personal area network (WPAN), a wireless wide area network (WWAN), or other network. In an embodiment, the WAN, WWAN, LAN, and WLAN may each include an access point 136 or base station 138 used to operatively couple the information handling system 100 and/or the HMD device 154 (e.g., via the HMD wireless radio) to a network 134. In a specific embodiment, the network 134 may include macro-cellular connections via one or more base stations 138 or a wireless access point 136 (e.g., Wi-Fi or WiGig), or such as through licensed or unlicensed WWAN small cell base stations 138. Connectivity may be via wired or wireless connection. For example, wireless network access points 136 or base stations 138 may be operatively connected to the information handling system 100 and, in an embodiment, the HMD device 154. Wireless interface adapter 126 may include one or more radio frequency (RF) subsystems (e.g., radio 128) with transmitter/receiver circuitry, modem circuitry, one or more antenna front end circuits 130, one or more wireless controller circuits, amplifiers, antennas 132 and other circuitry of the radio 128 such as one or more antenna ports used for wireless communications via multiple radio access technologies (RATs). The radio 128 may communicate with one or more wireless technology protocols. In and embodiment, the radio 128 may contain individual subscriber identity module (SIM) profiles for each technology service provider and their available protocols for any operating subscriber-based radio access technologies such as cellular LTE communications.

In an example embodiment, the wireless interface adapter 126, radio 128, and antenna 132 and HMD wireless radio 168 may provide connectivity to one or more of the peripheral devices that may include a wireless video display device 142, a wireless keyboard 144, a wireless mouse 150, a wireless headset such as the HMD device 154, a microphone, an audio headset, a wireless stylus 146, and a wireless trackpad 148, among other wireless peripheral devices used as input/output (I/O) devices 140 including any XR handheld controller 156 associated with the HMD device 154. In an embodiment, the HMD device 154 may include a wireless radio and an antenna to wirelessly couple the HMD device 154 to the information handling system 100 via the antenna 132 and radio 128. In an embodiment, the HMD device 154 may operate with Bluetooth radio protocols. In other embodiments, the HMD device 154 may operate with Wi-Fi 802.11 radio protocol, 5G NR radio protocols, or other wireless protocols. In an embodiment, an antenna controller operatively coupled to an operating system (OS) 114 may concurrently transceive data to and from various wireless devices such as the HMD device 154 or network 134 while an HMD processing device 170 of the HMD device 154 executes the applications being used in operation with the HMD device 154. In an embodiment, the processing device that executes the applications along with other processes associated with the operation of the HMD device 154 may be a processing device on the information handling system 100 (e.g., processor 102, GPU 152, among others described herein), at the HMD device 154 (e.g., HMD processor 170), or a combination of processors on these devices. In one embodiment, the HMD device 154 may be operatively coupled to the information handling system 100 via a wired connection to the bus 116, via, for example, a port in the information handling system 100.

The XR handheld controller 156 may be a peripheral input/output device 140 used by the user to interact with virtual images presented to the user via the HMD device 154. In an embodiment, the XR handheld controller 156 may be operatively coupled to the information handling system 100 via a wireless connection using the wireless interface adapter 126 operatively coupled to the bus 116. In this embodiment, input signals from the XR handheld controller 156 may be relayed to the processor 102, the HMD processor 170, or other processing device and used as input to manipulate an XR image presented to the user at the HMD device 154. In an optional embodiment, the XR handheld controller 156 may be operatively coupled to the bus 116 via a wired connection and receive this input as described. In another embodiment, the XR handheld controller 156 may be operatively coupled to the HMD device 154 via a wireless connection via operation of the HMD wireless radio 168 communicating with the radio 128 of the information handling system 100 or a wireless module on the XR handheld controller 156. In an example embodiment, the XR handheld controller 156 may provide input to a processing device (e.g., HMD processor 170) at the HMD device 154 to manipulate an XR image presented to the user at the HMD device 154. In another example embodiment, the XR handheld controller 156, being operatively coupled to the bus 116 or wireless interface adapter 126, may provide input to the processor 102 of the information handling system 100 to manipulate an XR image presented to the user at the HMD device 154. In one example embodiment, the GPU 152 of the information handling system 100 may be used to process and generate the graphics used to create the XR environment at the HMD device 154 as well as process those signals received by the XR handheld controller 156.

As described, the wireless interface adapter 126 and the HMD wireless radio 168 may include any number of antennas 132 which may include any number of tunable antennas for use with the system and methods disclosed herein. Although FIG. 1 shows a single antenna 132, the present specification contemplates that the number of antennas 132 may include more or less of the number of individual antennas shown in FIG. 1. Additional antenna system modification circuitry (not shown) may also be included with the wireless interface adapter 126 to implement coexistence control measures via an antenna controller in various embodiments of the present disclosure.

In some aspects of the present disclosure, the wireless interface adapter 126 may operate two or more wireless links. In an embodiment, the wireless interface adapter 126 may operate a Bluetooth wireless link using a Bluetooth wireless protocol. In an embodiment, the Bluetooth wireless protocol may operate at frequencies between 2.402 to 2.48 GHz. Other Bluetooth operating frequencies are also contemplated in the presented description. In an embodiment, a Bluetooth wireless link may be used to wirelessly couple the input/output devices operatively and wirelessly including the XR handheld controller 156, mouse 150, keyboard 144, stylus 146, trackpad 148, and/or video display device 142 to the bus 116 in order for these devices to operate wirelessly with the information handling system 100. In a further aspect, the wireless interface adapter 126 may operate the two or more wireless links with a single, shared communication frequency band such as with the 5G standard relating to unlicensed wireless spectrum for small cell 5G operation or for unlicensed Wi-Fi WLAN operation in an example aspect. For example, a 2.4 GHz/2.5 GHz or 5 GHz wireless communication frequency bands may be apportioned under the 5G standards for communication on either small cell WWAN wireless link operation or Wi-Fi WLAN operation. In some embodiments, the shared, wireless communication band may be transmitted through one or a plurality of antennas 132 may be capable of operating at a variety of frequency bands. In a specific embodiment described herein, the shared, wireless communication band may be transmitted through a plurality of antennas used to operate in an N×N MIMO array configuration where multiple antennas 132 are used to exploit multipath propagation which may be any variable N. For example, N may equal 2, 3, or 4 to be 2×2, 3×3, or 4×4 MIMO operation in some embodiments. Other communication frequency bands, channels, and transception arrangements are contemplated for use with the embodiments of the present disclosure as well and the present specification contemplates the use of a variety of communication frequency bands. As described herein, the HMD device 154 also includes an antenna system (e.g., HMD wireless radio 168) used to transceive data to and from the information handling system 100 using these wireless communication protocols described herein. Additionally, or alternatively, the HMD wireless radio 168 within the HMD device 154 may be used to communicate wirelessly with a remote server at the network 134 via an access point 136 or base station 138.

The wireless interface adapter 126 may operate in accordance with any wireless data communication standards. To communicate with a wireless local area network, standards including IEEE 802.11 WLAN standards (e.g., IEEE 802.11ax-2021 (Wi-Fi 6E, 6 GHz)), IEEE 802.15 WPAN standards, WWAN such as 3GPP or 3GPP2, Bluetooth standards, or similar wireless standards may be used. Wireless interface adapter 126 may connect to any combination of macro-cellular wireless connections including 2G, 2.5G, 3G, 4G, 5G or the like from one or more service providers. Utilization of radio frequency communication bands according to several example embodiments of the present disclosure may include bands used with the WLAN standards and WWAN carriers which may operate in both licensed and unlicensed spectrums. For example, both WLAN and WWAN may use the Unlicensed National Information Infrastructure (U-NII) band which typically operates in the −5 MHz frequency band such as 802.11 a/h/j/n/ac/ax (e.g., center frequencies between 5.170-7.125 GHz). WLAN, for example, may operate at a 2.4 GHz band, 5 GHz band, and/or a 6 GHz band according to, for example, Wi-Fi, Wi-Fi 6, or Wi-Fi 6E standards. WWAN may operate in a number of bands, some of which are proprietary but may include a wireless communication frequency band. For example, low-band 5G may operate at frequencies similar to 4G standards at 600-850 MHz. Mid-band 5G may operate at frequencies between 2.5 and 3.7 GHz. Additionally, high-band 5G frequencies may operate at 25 to 39 GHz and even higher. In additional examples, WWAN carrier licensed bands may operate at the new radio frequency range 1 (NRFR1), NFRF2, bands, and other known bands. Each of these frequencies used to communicate over the network 134 may be based on the radio access network (RAN) standards that implement, for example, eNodeB or gNodeB hardware connected to mobile phone networks (e.g., cellular networks) used to communicate with the information handling system 100. In the example embodiment, the information handling system 100 may also include both unlicensed wireless RF communication capabilities as well as licensed wireless RF communication capabilities. For example, licensed wireless RF communication capabilities may be available via a subscriber carrier wireless service operating the cellular networks. With the licensed wireless RF communication capability, a WWAN RF front end (e.g., antenna front end 130 circuits) of the information handling system 100 may operate on a licensed WWAN wireless radio with authorization for subscriber access to a wireless service provider on a carrier licensed frequency band.

In other aspects, the information handling system 100 operating as a mobile information handling system may operate a plurality of wireless interface adapters 126 for concurrent radio operation in one or more wireless communication bands. The plurality of wireless interface adapters 126 may further share a wireless communication band or operate in nearby wireless communication bands in some embodiments. Further, harmonics and other effects may impact wireless link operation when a plurality of wireless links are operating concurrently as in some of the presently described embodiments.

The wireless interface adapter 126 can represent an add-in card, wireless network interface module that is integrated with a main board of the information handling system 100 or integrated with another wireless network interface capability, or any combination thereof. In an embodiment the wireless interface adapter 126 or an HMD wireless radio 168 may include one or more radio frequency subsystems including transmitters and wireless controllers for connecting via a multitude of wireless links. In an example embodiment, an information handling system 100 may have an antenna system transmitter for Bluetooth, 5G small cell WWAN, or Wi-Fi WLAN connectivity and one or more additional antenna system transmitters for macro-cellular communication. The RF subsystems and radios 128 and for the HMD wireless radio 168 include wireless controllers to manage authentication, connectivity, communications, power levels for transmission, buffering, error correction, baseband processing, and other functions of the wireless interface adapter 126 and for the HMD wireless radio 168.

In an embodiment, the HMD device 154 may include its own XR software platform and applications. For example, the HMD device 154 may include a game engine such as Unity® developed by Unity Technologies or Unreal® developed by Epic Games that may be used to help design the XR software used to operate the HMD device 154. The HMD device 154 may also include standards such as Open XR® developed by Khronos Group that allows developers to build applications that may work across a variety of HMD devices 154. Development kits such as Vuforia®, Nvidia Omniverse® developed by Nvidia GTC, ARCore® developed by Google, Qualcomm XR® developed by Qualcomm, may also be executed by the HMD device 154 in order to provide for the development of AR applications and mark less tracking algorithms and computer code to be executed by the HMD device 154. These kits and standards, among others, may be used to develop executable program code and provide content to the user at the HMD device 154.

In an embodiment, the HMD device 154 may include its own wireless interface adapter, radio, antenna front end, and antenna such as the HMD wireless radio 168. This may allow the HMD device 154 to communicate with the information handling system 100 or, alternatively, directly to a network maintaining a remote server used to provide the XR environment to the user (e.g., software as a service, storage as a service, processing as a service). As such, this wireless interface adapter, radio, antenna front end, and antenna of the HMD wireless radio 168 may conserve processing resources of the HMD processor 170 and/or processor 102/GPU 152 of the HMD device 154 and information handling system 100 if necessary. With the wireless interface adapter, radio, antenna front end, and antenna of the HMD wireless radio 168 of the HMD device 154, the HMD device 154 may communicate with the information handling system 100 or the network 134 via an out-of-band (OOB) communication channel, for example. The OOB communication may initially facilitate the communication of the HMD device 154 with the information handling system 100 or some external sensors via, for example, Bluetooth or Wi-Fi communication protocols. In an embodiment, the OOB communication may also be accomplished using those wireless communication protocols described in connection with the operation of the wireless interface adapter 126. In an embodiment, this OOB communication may occur below the basic input/output system (BIOS) 112 or OS 114 allowing the communication to proceed in the background of other processes being executed by the processor 102 or other processing device such as the GPU 152. This allows the processing resources of the processor 102 or GPU 152 of the information handling system 100 or the processing devices of the HMD device 154 to be conserved for other processing tasks associated with the processing of XR images and data associated with the display of those images to the user via the video display of the HMD device 154.

During operation, the information handling system 100 may communicate with the HMD device 154 either via a wired connection or wirelessly as described herein. The operation of the HMD device 154 may not be dependent on the information handling system 100 being in operation, in an embodiment, and the HMD device 154 may be used by the user whether the information handling system 100 is operatively coupled to the HMD device 154 or not, in some embodiments.

In an embodiment, the HMD device 154 may include the necessary hardware used to display an XR image of a surrounding physical environment while tracking the location of the HMD device 154 (and the user) within the physical environment. This hardware used may vary depending on the type of process used to display the XR image to the user. Example processes may be grouped into two general categories: inside-out positional tracking processes and outside-in tracking processes. Although, the present specification contemplates the use of outside-in tracking processes (e.g., tracking cameras and sensors placed outside of the HMD device 154), for convenience in description, the present specification describes an HMD device 154 the operates using an inside-out process of tracking the HMD device 154. With the inside-out process of tracking the HMD device 154, the HMD device 154 includes a camera/pass-through camera 160 and other sensors used to determine the location of the HMD device 154 as it moves within an environment, in an embodiment. In an embodiment, the HMD device 154 may include positional sensors such as a global positioning system (GPS) unit, an inertial measurement unit (IMU), an e-Compass unit, and/or other positional measurement tools such as an accelerometer, a capacitive transducer, a hall effect sensor, a laser doppler vibrometer, a multi-axis displacement transducer, a potentiometer, or a confocal chromatic sensor. Other positional sensors are also contemplated, including a capacitive displacement sensor, an eddy-current sensor, an ultrasonic sensor, a grating sensor, an inductive non-contact position sensor, a linear variable differential transformer, a photodiode array, a piezo-electric transducer, a proximity sensor, a rotary encoder, a seismic displacement pick-up, and a string potentiometer, along with any other positional sensors developed in the future. The positional sensors (e.g., GPS unit, IMU, and/or eCompass unit) in an embodiment may operate to measure location coordinates (x, y, z) of the HMD device 154, as well as orientation (θ), velocity, and/or acceleration. Velocity, acceleration, and trajectory of the HMD device 154 in such an embodiment may be determined by comparing a plurality of measured location coordinates and orientations taken over a known period of time, or may be measured directly by onboard positional sensor such as an accelerometer. Additionally, or alternatively, Wi-Fi triangulation or other wireless multilateration may be used that uses the characteristics of nearby Wi-Fi hotspots and other wireless access points 136 or base station nodes 138 to discover where within an environment the HMD device 154 is located. Additionally, or alternatively, an Internet-of-Things (IoT) device may be used that include sensors that may be detectable by the HMD device 154 and provides data to the HMD device 154 that it is within a physical environment.

In an embodiment, a simultaneous localization and mapping (SLAM) engine executing a SLAM process (described herein), the IoT devices, and the Wi-Fi hotspot triangulation process may all be used as data inputs to the head mounted display CPU/GPU, the processor 102 of the information handling system 100, or other operatively coupled processing resource to better determine the initial configuration and location of the HMD device 154. In an embodiment, the OOB communication channel may help to communication wirelessly with some of these sensors when determining the location of the HMD device 154. Again, in an embodiment, the HMD device 154 may include an embedded controller that operates this OOB communication link so that this communication may be conducted below the operating system of the HMD device 154. This prevents the HMD processor 170 (e.g., a processor, GPU, CPU, or other microcontroller, etc.) from having to receive and compute this data leaving the HMD processor 170 to conduct, for example, the SLAM computations described herein.

The HMD device 154 may also be capable of capturing video or still images of its surrounding environment, which may include one or more identifiable landmarks. For example, the HMD device 154 may include one or more cameras such as the camera/pass-through camera 160. These cameras may capture two-dimensional images of the surrounding environment, which may be combined with distance measurements gathered by a plurality of, for example, IR emitters and detectors to generate a three-dimensional image of the surrounding environment. The cameras, in an embodiment, may be, for example, a stereo triangulation camera, an Infrared (IR) camera, a sheet of light triangulation camera, a structured light camera, a time-of-flight or time of arrival camera, an interferometry camera, a coded aperture camera, a RGB digital camera, an infrared digital camera, a telephoto lens digital camera, a fish-eye digital camera, a wide-angle digital camera, a close-focus digital camera, or any other type of camera. The three-dimensional image generated by a processing device (e.g., the HMD processor 170, GPU 152, or processor 102 and the like) in an embodiment may be used to determine the position and orientation of the HMD device 154 with respect to the one or more landmarks with respect to the physical surroundings as well as any virtual images in a projected XR setting on the HMD device 154.

In an embodiment, a processing device either on the HMD device 154 (e.g., HMD processor 170) itself or the processor 102 in operative communication with the HMD device 154 may process this received data from these sensors and the camera in order to facilitate the presentation of an XR image of a surrounding environment to a user via a video display on the HMD device 154 as described herein. This may be done using, for example the SLAM process. The SLAM process, in an embodiment, may be employed in order to identify the position of the headset with respect to its surrounding environment, model the surrounding environment as viewed from the perspective of the headset wearer, and render the modeled image in a three-dimensional environment matching the surrounding real-world environment. The surrounding environment may be virtual or some combination of physical and virtual for XR. It does this by a processing device (e.g., processor 102 or the HMD processor 170 of the period HMD device 154) executing computer readable program code describing an algorithm that concurrently maps a surrounding XR environment the HMD device 154 is within and detects the position of the HMD device 154 within that surrounding XR environment. IR emitters and sensors housed within or mounted on the exterior surfaces of the HMD device 154 may measure such distances in an embodiment. IR emitters and sensors may be mounted in all directions around the exterior surface of the HMD device 154, in some embodiments. In other embodiments, only portions of the exterior surfaces of the wearable headsets may have infrared emitters and sensors or cameras. For example, the HMD device 154 may emit IR light in a pattern toward the physical landmark, the HMD device 154 may emit IR light, and/or the HMD device 154 may emit IR light toward the physical landmark. The cameras mounted to the HMD device 154 may then capture an image of each of the IR lights reflecting off the surfaces of the physical landmark. If the surrounding environment further includes other ambient light sources, the cameras will also detect illumination from the physical landmark reflecting such ambient light. For example, if desk lamp and/or floor lamp are turned on, the physical landmark in an embodiment may reflect ambient light generated by the lamps.

The depth of surfaces of nearby objects may be determined by analyzing the way in which the pattern of emitted IR light is distorted as it reaches surfaces of varying distances from the headset. For example, the HMD device 154 may determine the depth of the physical landmark by analyzing the way in which the pattern of emitted IR light is distorted as it reaches the surfaces of physical landmark. Similarly, the HMD device 154 may determine the depth of the physical landmark by analyzing the way in which the pattern of emitted IR light is distorted as it reaches the surfaces of physical landmark, and the HMD device 154 may determine the depth of the physical landmark by analyzing the way in which the pattern of emitted IR light is distorted as it reaches the surfaces of physical landmark. With this data and the other data from the other sensors described herein, the processing device may execute the algorithm defining the SLAM process in order to render to a user via the video display of the HMD device 154 an XR image based on a rendered image from the model generated and referenced movement within the surrounding XR environment based on movement of the HMD device 154 relative to physical landmarks.

During operation of the information handling system 100, the user may want to interact with the applications currently being executed on the HMD video display 176 by the HMD device 154. To do so, the user may wear the HMD device 154 by aligning the HMD video display 176 with the user's eyes thereby placing an HMD housing 160 against the user's face surrounding the user's eyes. A head strap may then be secured around the back of the user's head thereby securing the HMD device 154 to the user's head. In an embodiment, the HMD housing 160 may include a face mask that is a padded surface that contacts the user's face to provide additional comfort to the user.

In order to also make the user more comfortable, the HMD device 154 may include a swappable nose bridge 172. The swappable nose bridge 172 may be a removable part of the HMD housing 160 that contacts the user's nose when the HMD device 154 is placed on the user's head. In an embodiment, the swappable nose bridge 172 may be one of a plurality of swappable nose bridges 172 available to the user to operatively couple to the HMD housing 160. These plurality of swappable nose bridges 172 may be of different sizes, shapes, or colors to accommodate the user or a plurality of user's when interfacing with the HMD device 154. For example, a first user may have a relatively smaller nose than a second user and the plurality of swappable nose bridges 172 may be differentiated by different sizes and shapes to accommodate these differences in physiology between, in this example, nose sizes or shapes of the first user and the second user. In an embodiment, the plurality of swappable nose bridges 172 may be of different colors or may include other differentiating features (e.g., symbols) that allow a user to know which of the plurality of swappable nose bridges 172 belongs to that size or user. Using the HMD device 154 may cause different bacteria or viruses to be transmitted from one user to another. In order to mitigate this, each user may use their own swappable nose bridge 172 that is differentiated by color, for example, in order to the user to readily swap in their assigned or owned swappable nose bridge 172 to use with the HMD device 154.

As described herein, the swappable nose bridge 172 may be operatively coupled to the HMD housing 160. As described herein, the HMD housing 160 of the HMD device 154 may include a nose bridge slot 178. This nose bridge slot 178 may receive a nose bridge extension 174 of the swappable nose bridge 172. The nose bridge extension 174 may be sized to fit within the nose bridge slot 178 easily so that the user may exchange one of a plurality of swappable nose bridges 172 with another where, for example, the first user needs to have a swappable nose bridge 172 that is owned by the user or sized to fit the user as described herein. In an embodiment, the nose bridge extension 174 may be sized to create an interference fit within the nose bridge slot 178. The level of interference fit may be such that the swappable nose bridge 172 is not easily separatable from the HMD housing 160 except by the user applying sufficient force to remove the nose bridge extension 174 from within the nose bridge slot 178.

In an embodiment, the nose bridge extension 174 may include a nose bridge magnet 180. The nose bridge magnet 180 may interface with a metal portion within the nose bridge slot 178 such as a ferromagnetic metal keep 186. In an embodiment, the ferromagnetic metal keep 186 may be made of a ferromagnetic material that magnetically interacts with the nose bridge magnet 180 to help secure the nose bridge extension 174 within or attached to the nose bridge slot 178 and, accordingly, the swappable nose bridge 172 to the HMD housing 160. In an embodiment, the nose bridge magnet 180 may be embedded within the nose bridge extension 174. In an embedded embodiment, the material of the swappable nose bridge 172 may conceal the presence of the nose bridge magnet 180. In an embodiment, the swappable nose bridge 172 may be manufactured by placing the nose bridge magnet 180 within a mold and the material forming the swappable nose bridge 172 may be injection molded into the mold to secure the nose bridge magnet 180 within the nose bridge extension 174. In an embodiment, the material forming the swappable nose bridge 172 may be a pliable plastic, rubber, or synthetic rubber that is capable of being injection molded into a mold, for example. In the case where rubber or synthetic rubber is used, the surface of the rubber or synthetic rubber may increase the friction between the surfaces of the swappable nose bridge 172 and the user's nose. This may increase the ability of the swappable nose bridge 172 and the HMD device 154 to be retained on the user's face and not move on the user's face while in use. In an embodiment, the nose bridge magnet 180 may be a ferromagnetic magnet, a neodymium magnet, or any other type of permanent magnet.

In an embodiment, the swappable nose bridge 172 may include a nose bridge collar 182. The nose bridge collar 182 may be a portion of the swappable nose bridge 172 that conforms to an outside surface of the HMD housing 160. The nose bridge collar 182 may conform to the outside surface of the HMD housing 160 in order to prevent light from entering the area between the HMD video display 176 and the user's eyes thereby creating a lightproof environment. By providing this lightproof environment via the nose bridge collar 182, the user may better see the images and video presented to the user via the HMD video display 176. In an embodiment, the nose bridge collar 182 may be formed within the mold used to form the swappable nose bridge 172 as described herein. In an embodiment, the nose bridge collar 182 may abut any portion of the HMD housing 160 including a face mask that abuts the user's face when the HMD device 154 is being worn.

In an embodiment, the swappable nose bridge 172 may include a nose bridge slit 184 formed through a portion of the swappable nose bridge 172. The nose bridge slit 184 may be formed along a portion of the swappable nose bridge 172 where a ridge of the user's nose may contact the swappable nose bridge 172. The nose bridge slit 184 may, in an embodiment, create two nose bridge flaps that separate the portion of the swappable nose bridge 172 that contacts the user's nose when the HMD device 154 is being worn. In an embodiment, the nose bridge flaps formed by the nose bridge slit 184 may include a shape memory alloy internal structure such as a sheet, rod or wire embedded in the nose bridge flaps to allow a portion of the nose bridge contacting the user's nose to be elastically deformed to conform to a shape of the user's nose. This shape memory alloy structure may be a rod, wire, or sheet of, for example, metal alloys that includes one or more of copper, aluminum, cadmium, nickel, gallium, gold, iron, silicon, beryllium, palladium, zinc, platinum, niobium, hafnium, manganese, cobalt, tin, among other metals and non-metals in different proportions. In an embodiment, a sheet of shape memory alloy structure may be embedded into the nose bridge flaps created by the nose bridge slit 184. In an embodiment, the shape memory alloy structure may be embedded into the nose bridge flaps using the injection molding process described herein. In an embodiment, the injection molding process may include inserting the rod, wire, or sheet of shape memory alloy into a mold and injecting a pliable plastic, rubber, or synthetic rubber into the mold and secure the sheet or sheets of shape memory alloy into the nose bridge flaps. In an embodiment, this injection molding process may be completed concurrently with the injection molding process used to secure the nose bridge magnet 180 within the nose bridge extension 174 as described herein. The shape memory alloy structure formed into the nose bridge flaps allows the portions of the swappable nose bridge 172 that touches the user's nose to be elastically deflected to conform to the surface of the user's nose. This increases the adjustability and comfortability of the swappable nose bridge 172 as the HMD housing 160 is placed on the user's head.

The information handling system 100 can include one or more set of instructions 110 that can be executed to cause the computer system to perform any one or more of the methods or computer-based functions disclosed herein. For example, instructions 110 may execute a XR software applications or APIs, various software applications, software agents, or other aspects or components. Various software modules comprising application instructions 110 may be coordinated by an operating system (OS) 114, and/or via an application programming interface (API). An example OS 114 may include Windows®, Android®, and other OS types known in the art. Example APIs may include Win 32, Core Java API, or Android APIs.

The disk drive unit 118 and may include a computer-readable medium 108 in which one or more sets of instructions 110 such as software can be embedded to be executed by the processor 102 or other processing devices such as a GPU 152 to perform the processes described herein. Similarly, main memory 104 and static memory 106 may also contain a computer-readable medium for storage of one or more sets of instructions, parameters, or profiles 110 described herein. The disk drive unit 118 or static memory 106 also contain space for data storage. Further, the instructions 110 may embody one or more of the methods as described herein. In a particular embodiment, the instructions, parameters, and profiles 110 may reside completely, or at least partially, within the main memory 104, the static memory 106, and/or within the disk drive 116 during execution by the processor 102 or GPU 152 of information handling system 100. The main memory 104, GPU 152, and the processor 102 also may include computer-readable media.

Main memory 104 or other memory of the embodiments described herein may contain computer-readable medium (not shown), such as RAM in an example embodiment. An example of main memory 104 includes random access memory (RAM) such as static RAM (SRAM), dynamic RAM (DRAM), non-volatile RAM (NV-RAM), or the like, read only memory (ROM), another type of memory, or a combination thereof. Static memory 106 may contain computer-readable medium (not shown), such as NOR or NAND flash memory in some example embodiments. The applications and associated APIs described herein, for example, may be stored in static memory 106 or on the drive unit 118 that may include access to a computer-readable medium 108 such as a magnetic disk or flash memory in an example embodiment. While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the methods or operations disclosed herein.

In an embodiment, the information handling system 100 may further include a power management unit (PMU) 120 (a.k.a. a power supply unit (PSU)). The PMU 120 may manage the power provided to the components of the information handling system 100 such as the processor 102, a cooling system, one or more drive units 118, the GPU 152, a video/graphic display device 142 or other input/output devices 140 such as the stylus 146, a mouse 150, a keyboard 144, and a trackpad 148 and other components that may require power when a power button has been actuated by a user. In an embodiment, the PMU 120 may monitor power levels and be electrically coupled, either wired or wirelessly, to the information handling system 100 to provide this power and coupled to bus 116 to provide or receive data or instructions. The PMU 120 may regulate power from a power source such as a battery 122 or A/C power adapter 124. In an embodiment, the battery 122 may be charged via the A/C power adapter 124 and provide power to the components of the information handling system 100 via a wired connections as applicable, or when A/C power from the A/C power adapter 124 is removed.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

In other embodiments, dedicated hardware implementations such as application specific integrated circuits (ASICs), programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

When referred to as a “system”, a “device,” a “module,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). The system, device, controller, or module can include software, including firmware embedded at a device, such as an Intel® Core class processor, ARM® brand processors, Qualcomm® Snapdragon processors, or other processors and chipsets, or other such device, or software capable of operating a relevant environment of the information handling system. The system, device, controller, or module can also include a combination of the foregoing examples of hardware or software. Note that an information handling system can include an integrated circuit or a board-level product having portions thereof that can also be any combination of hardware and software. Devices, modules, resources, controllers, or programs that are in communication with one another need not be in continuous communication with each other, unless expressly specified otherwise. In addition, devices, modules, resources, controllers, or programs that are in communication with one another can communicate directly or indirectly through one or more intermediaries.

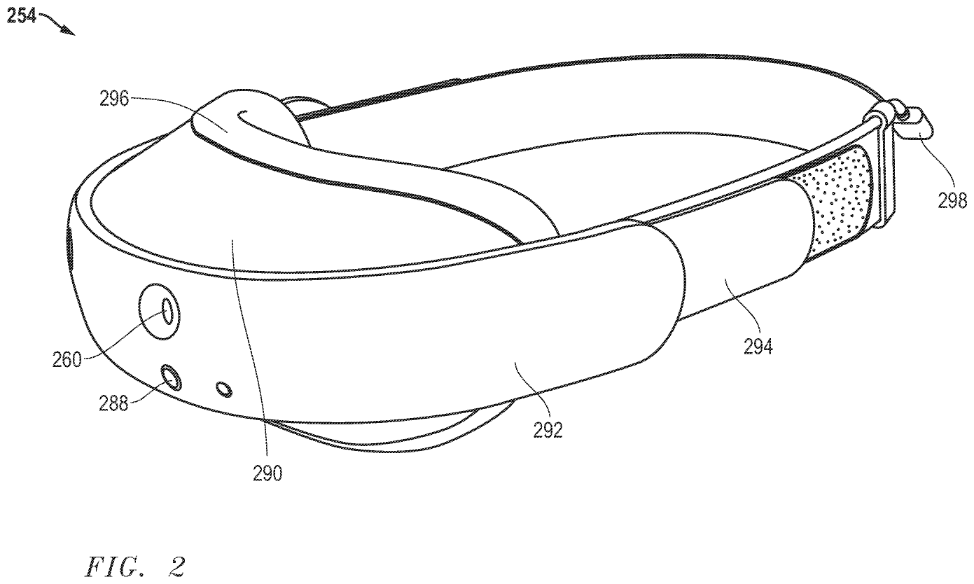

FIG. 2 is a graphic diagram perspective view illustrating an HMD device 254 according to an embodiment of the present disclosure. The general shape and form of the HMD device 254, in an embodiment, may be similar to a pair of wrap-around goggles. In an embodiment, the HMD device 254 may be as lightweight as possible in order to place the least amount of weight on the user's face and head during use. As such, the HMD device 254 may include an HMD connection wire 298 used to operatively couple the HMD device 254 to a processing and storage resource such as a wearable computer stick in some embodiments. In an embodiment, this processing and storage resource may be an information handling system similar to the information handling system described in connection with FIG. 1. In an embodiment, this processing and data storage resource may be a compute stick that includes the hardware such as a GPU/video processor, a data storage device, a power management unit, a power source (e.g., a battery) among other hardware that may be operatively coupled to the HMD device 254 but could be placed offsite from the HMD device 254 in order to reduce the weight of the HMD device 254 on the user's head. This compute stick, in an embodiment, may include a strap or other securing device that allows the user to secure the compute stick to the user's body (e.g., an arm) when operating the HMD device 254. In an embodiment, this offsite compute stick may be operatively coupled to the HMD video display (e.g., 176, FIG. 1, not shown in FIG. 2) of the HMD device 254 in order to provide video/image data to the user during use.

The HMD device 254 may include an HMD shield 292 in an embodiment. The HMD shield 292 may act as part of the housing on to which other components of the HMD device 254 may be secured or into which some of the hardware of the HMD device 254 may be placed. For example, the HMD device 254 may include a camera/pass-through camera 260 used to provide data to a processing resource describing the location of the HMD device 254 within a physical environment. Additionally, the camera/pass-through camera 260 may provide images to the user via the HMD video display of the physical environment around the user. The camera/pass-through camera 260 may be formed into a front or a side portion of the HMD shield 292 and is protected from damage by the rigid housing of the HMD shield 292.

The HMD shield 292 may also house an IR detector/IR emitter 288. In an embodiment, the IR detector/IR emitter 288 or visible light versions of the same, for example, within either on the HMD device 254 (e.g., inward-out location detection) or located within the physical environment (e.g., outward-in location detection), may be used to triangulate or multilaterate the location of the HMD device 254 within the physical environment. In the example embodiment shown in FIG. 2, the IR detector/IR emitter 288 may also be placed within the housing of the HMD shield 292 to protect the IR detector/IR emitter 288 from damage. Again, the data obtained from the IR detector/IR emitter 288 may be used by a SLAM engine executed by the processing resources described herein. The SLAM engine, in an embodiment, may access the position/orientation information for the one or more landmarks or beacons with respect to the HMD device 254 generated or received by the HMD CPU/GPU/XR processor, the data from the IR detector/IR emitter 288, and other orientation data described herein, and use this information to generate a three-dimensional virtual map of HMD device 254 and its surrounding environment, including the one or more identified landmarks. In other example embodiments, the HMD CPU/GPU/XR processor may receive one or more SLAM frames including three-dimensional virtual maps of the HMD device 254 and its surrounding environment from the remotely located laptop or desktop information handling system via a network adapter.

The HMD shield 292 may also include an HMD shroud 290 operatively coupled to the HMD shield 292. Again, because the area between the user's eyes and the HMD video display needs to be dark, the HMD shroud 290 may prevent light from entering this area. In an embodiment, the HMD shroud 290 may be lightproof so that the user may view the images and videos presented to the user at the HMD video display. In an embodiment, the HMD shroud 290 may include a frame (not shown) that maintains a shape of the HMD shroud 290 around the user's eyes and away from the HMD video display. In an embodiment, the frame and HMD shroud 290 may include a face mask 296 used to abut a user's face when the HMD device 254 is worn. The face mask 296 may be made of a pliable material such as a foam, synthetic rubber, or silicone in order to soften the interface between the HMD device 254 and the user's face making the wearing of the HMD device 254 more comfortable to the user.

The HMD device 254 may further include a head strap 294. In an embodiment, the head strap 294 may be operatively coupled to the HMD shield 292 and extend away from the HMD shield 292. The head strap 294 may be sized to fit around the back a user's head and is used to secure the HMD device 254 to the user's head and face. In an embodiment, the head strap 294 may include adjustable straps that allow the user to loosen or tighten the head strap 294 around the user's head. In an embodiment, the head strap 294 may be made of an elastic material that may stretch around the user's head when the HMD device 254 is being worn. In an embodiment, the head strap 294 may include a Velcro coupling device or a belt structure to allow the user to adjust the length of the head strap 294 for a customized fit.

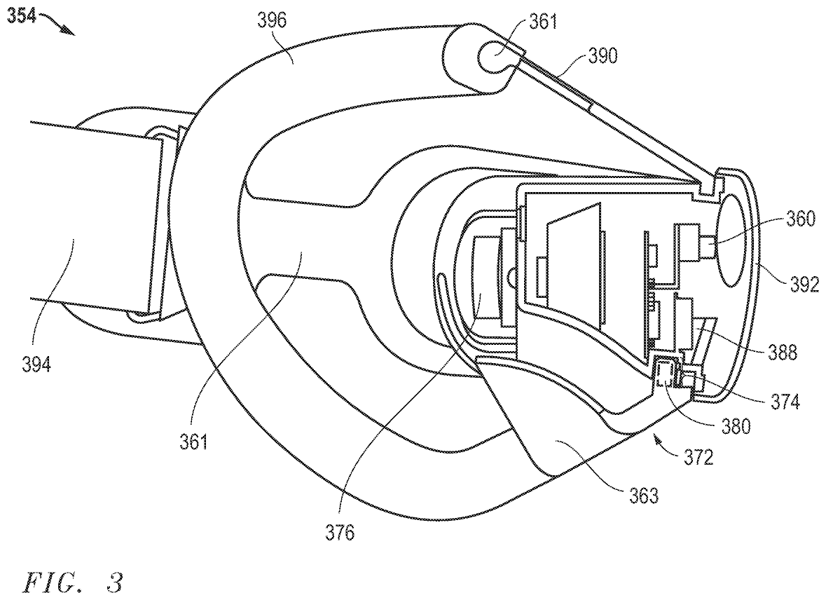

FIG. 3 is a graph image side, sectional view illustrating an HMD device 354 and with a swappable nose bridge 372 according to an embodiment of the present disclosure. This side, sectional view shows an interior portion of the HMD device 354. As described herein, the HMD device 354 may include an HMD shroud 390 operatively coupled to the HMD shield 392. Again, because the area between the user's eyes and the HMD video display 376 needs to be dark, the HMD shroud 390 may prevent light from entering this area. In an embodiment, the HMD shroud 390 may be lightproof so that the user may view the images and videos presented to the user at the HMD video display 376. In an embodiment, the HMD shroud 390 may include an HMD frame 361 that maintains a shape of the HMD shroud 390 around the user's eyes and away from the HMD video display 376. In an embodiment, the HMD frame 361 and HMD shroud 390 may include a face mask 396 used to abut a user's face when the HMD device 354 is worn. The face mask 396 may be made of a pliable material such as a foam, rubber, or silicone in order to soften the interface between the HMD device 354 and the user's face making the wearing of the HMD device 354 more comfortable to the user or may have adjustable velcro straps.

The HMD device 354 may further include a head strap 394. In an embodiment, the head strap 394 may be operatively coupled to the HMD shield 392 and extend away from the HMD shield 392. The head strap 394 may be sized to fit around the back a user's head and is used to secure the HMD device 354 to the user's head and face. In an embodiment, the head strap 394 may include adjustable straps that allow the user to loosen or tighten the head strap 394 around the user's head. In an embodiment, the head strap 394 may be made of an elastic material that may stretch around the user's head when the HMD device 354 is being worn.

The HMD device 354 may include an HMD shield 392 in an embodiment. The HMD shield 392 may act as part of the housing on to which other components of the HMD device 354 may be secured or into which some of the hardware of the HMD device 354 may be placed. For example, the HMD device 354 may include a camera/pass-through camera 360 used to provide data to a processing resource describing the location of the HMD device 354 within a physical environment. Additionally, the camera/pass-through camera 360 may provide images to the user via the HMD video display 376 of the physical environment around the user. The camera/pass-through camera 360 may be formed into a front portion of the HMD shield 392 and protected from damage by the rigid housing of the HMD shield 392 from damage.

The HMD shield 392 may also house an IR detector/IR emitter 388. In an embodiment, the IR detector/IR emitter 388 or visible light versions of the same, for example, within either on the HMD device 354 (e.g., inward-out location detection) or located within the physical environment (e.g., outward-in location detection), may be used to triangulate or multilaterate the location of the HMD device 354 within the physical environment. In the example embodiment shown in FIG. 3, the IR detector/IR emitter 388 may also be placed within the housing of the HMD shield 392 to protect the IR detector/IR emitter 388 from damage. Again, the data obtained from the IR detector/IR emitter 388 may be used by a SLAM engine executed by the processing resources described herein. The SLAM engine, in an embodiment, may access the position/orientation information for the one or more landmarks with respect to the HMD device 354 generated or received by the HMD CPU/GPU/XR processor, the data from the IR detector/IR emitter 388, and other orientation data described herein, and use this information to generate a three-dimensional virtual map of HMD device 354 and its surrounding environment, including the one or more identified landmarks. In other example embodiments, the HMD CPU/GPU/XR processor may receive one or more SLAM frames including three-dimensional virtual maps of the HMD device 354 and its surrounding environment from the remotely located laptop or desktop information handling system via a network adapter such as a wireless interface device. In an embodiment, the HMD CPU/GPU/XR processor may be mounted within the housing of the HMD shield 392 along with a memory device, a PMU, a power source (e.g., battery), and a wireless interface as described herein.

As described herein, the HMD device 354 includes a swappable nose bridge 372. In order to also make the user more comfortable and the HMD device 354 adjustable to fit, the HMD device 354 may include this swappable nose bridge 372. The swappable nose bridge 372 may be a removable part of the HMD housing such as the HMD shield 392 that contacts the user's nose when the HMD device 354 is placed on the user's head. In an embodiment, the swappable nose bridge 372 may be one of a plurality of swappable nose bridges 372 available to the user to operatively couple to the HMD shield 392. These plurality of swappable nose bridges 372 may be of different sizes, shapes, or colors to accommodate the user or a plurality of users when interfacing with the HMD device 354. For example, a first user may have a relatively smaller nose than a second user and the plurality of swappable nose bridges 372 may be differentiated by different sizes and shapes to accommodate these differences in physiology of nose size or nose shape between, in this example, a first user and a second user. In an embodiment, the plurality of swappable nose bridges 372 may be of different colors or may include other differentiating features (e.g., symbols) that allow a user to know which of the plurality of swappable nose bridges 372 belongs to that user or correspond to a particular size or nose shape. Using the HMD device 354 may cause different bacteria or viruses to be transmitted from one user to another. In order to mitigate this, each user may use their own swappable nose bridge 372 that is differentiated by color, for example, in order to the user to readily swap in their assigned or owned swappable nose bridge 372 to use with the HMD device 354.

As described herein, the swappable nose bridge 372 may be operatively coupled into a bottom side of the HMD shield 392. As described herein, the HMD shield 392 of the HMD device 354 may include a nose bridge slot. This nose bridge slot may receive a nose bridge extension 374 of the swappable nose bridge 372. The nose bridge extension 374 may be sized to fit within the nose bridge slot easily so that the user may exchange one of a plurality of swappable nose bridges 372 with another where, for example, the first user needs to have a swappable nose bridge 372 that is owned by the user or sized to fit the user as described herein. In an embodiment, the nose bridge extension 374 may be sized to create an interference fit within the nose bridge slot. The level of interference fit may be such that the swappable nose bridge 372 is not easily separatable from the HMD shield 392 except by the user applying force to overcome the interference or other fit and remove the nose bridge extension 374 from within the nose bridge slot.

In an embodiment, the nose bridge extension 374 may include a nose bridge magnet placed at a nose bridge magnet location 380. The nose bridge magnet at the nose bridge magnet location 380 may interface with a metal portion within the nose bridge slot 378 such as a ferromagnetic metal keep forming the inside surface of some or all of the nose bridge slot 378. In an embodiment, the ferromagnetic metal keep may be made of a ferromagnetic material that magnetically interacts with the nose bridge magnet at the nose bridge magnet location 380 to help secure the nose bridge extension 374 within the nose bridge slot 378 and, accordingly, the swappable nose bridge 372 to the HMD shield 392. In an embodiment, the nose bridge magnet at the nose bridge magnet location 380 may be embedded within the nose bridge extension 374. In this embodiment, the material of the swappable nose bridge 372 may conceal the presence of the nose bridge magnet. In an embodiment, the swappable nose bridge 372 may be manufactured by placing the nose bridge magnet within a mold and the material forming the swappable nose bridge 372 may be injection molded into the mold to secure the nose bridge magnet at the nose bridge magnet location 380 within the nose bridge extension 374. In an embodiment, the material forming the swappable nose bridge 372 may be a pliable plastic, rubber, or synthetic rubber that is capable of being injection molded into a mold, for example. In the case where rubber or synthetic rubber is used, the surface of the rubber or synthetic rubber may increase the friction between the surfaces of the swappable nose bridge 372 and the user's nose. This may increase the ability of the swappable nose bridge 372 and the HMD device 354 to be retained on the user's face and not move on the user's face while in use. In an embodiment, the magnet 380 can also be attached or fastened to the end of the nose bridge extension 374.

In an embodiment, the swappable nose bridge 372 may include a nose bridge collar. The nose bridge collar may be a portion of the swappable nose bridge 372 that conforms to an outside surface of the HMD shield 392, the HMD frame 361, and the face mask 396. The nose bridge collar may conform to the outside surface of the HMD shield 392 in order to prevent light from entering the area between the HMD video display 376 and the user's eyes thereby creating a lightproof environment. By providing this lightproof environment via the nose bridge collar, the user may better see the images and video presented to the user via the HMD video display 376. In an embodiment, the nose bridge collar may be formed within the mold used to form the swappable nose bridge 372 as described herein. In an embodiment, the nose bridge collar may abut any portion of the HMD device 354 including a face mask 396 that abuts the user's face when the HMD device 354 is being worn.

In an embodiment, the swappable nose bridge 372 may include a nose bridge slit (not shown) formed through a portion of the swappable nose bridge 372. The nose bridge slit may be formed along a portion of the swappable nose bridge 372 where a ridge of the user's nose may contact the swappable nose bridge 372. The nose bridge slit may, in an embodiment, create two nose bridge flaps 363 that separate the portion of the swappable nose bridge 372 that contacts the user's nose when the HMD device 354 is being worn. In an embodiment, the nose bridge flaps 363 formed by the nose bridge slit may include a shape memory alloy structure such as a sheet, rod, or wire embedded in the nose bridge flaps 363 to allow a portion of the swappable nose bridge 372 contacting the user's nose to be elastically deformed to conform or be fit to adjust to a shape of the user's nose. This shape memory alloy may be a sheet, rod, or wire of, for example, metal alloys that includes one or more of copper, aluminum, cadmium, nickel, gallium, gold, iron, silicon, beryllium, palladium, zinc, platinum, niobium, hafnium, manganese, cobalt, tin, among other metals and non-metals in different proportions. In an embodiment, a sheet, rod, or wire of the shape memory alloy may be embedded into the nose bridge flaps 363 created by the nose bridge slit. In an embodiment, the shape memory alloy structure may be embedded into the nose bridge flaps 363 using the injection molding process described herein. In an embodiment, the injection molding process may include inserting the structure (e.g., sheet, rod, or wire) of shape memory alloy into a mold and injecting a pliable plastic, rubber, or synthetic rubber into the mold and secure the sheet or sheets of shape memory alloy into the nose bridge flaps 363. In an embodiment, this injection molding process may be completed concurrently with the injection molding process used to secure the nose bridge magnet at the nose bridge magnet location 380 within the nose bridge extension 374 as described herein. The shape memory alloy structure formed into the nose bridge flaps 363 allows the portions of the swappable nose bridge 372 that touches the user's nose to be elastically deflected or bent into a position to conform to the surface of the user's nose. This increases the comfortability and adjustability of the swappable nose bridge 372 as the HMD device 354 is placed on the user's head.

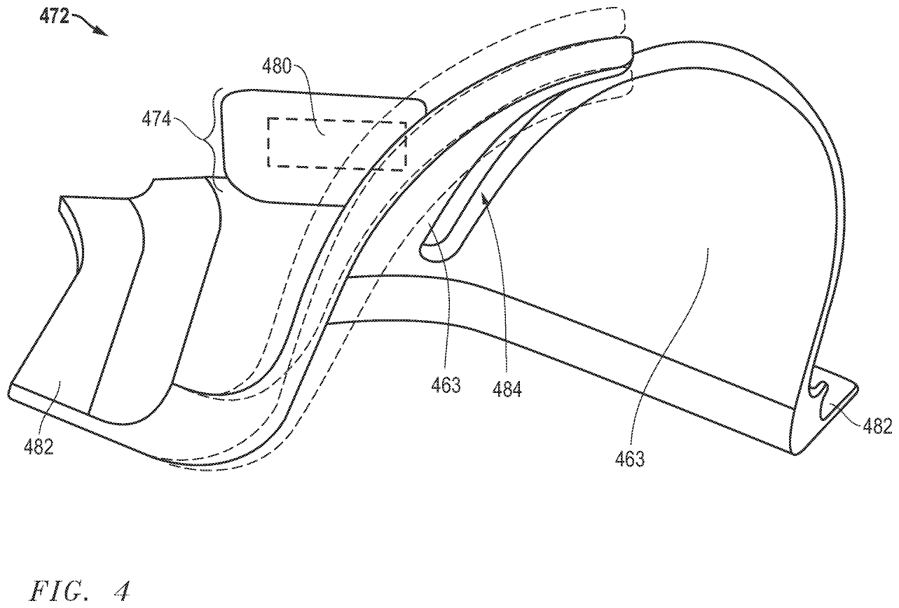

FIG. 4 is a graphic diagram perspective view of a swappable nose bridge 472 of an XR HMD device according to an embodiment of the present disclosure. In order to also make the user more comfortable, the HMD device may include this swappable nose bridge 472. The swappable nose bridge 472 may be a removable part of the HMD housing such as the HMD shield. The swappable nose bridge 472 contacts the user's nose when the HMD device is placed on the user's head. In an embodiment, the swappable nose bridge 472 may be one of a plurality of swappable nose bridges 472 available to the user to operatively couple to the HMD shield. These plurality of swappable nose bridges 472 may be of different sizes, shapes, or colors to accommodate the user or a plurality of user's when interfacing with the HMD device. For example, a first user may have a relatively smaller nose than a second user and the plurality of swappable nose bridges 472 may be differentiated by different sizes and shapes to accommodate these differences is physiology between, in this example, the first user and the second user. The differences in physiology include the different nose shapes of the users that nay be hooked, shallow ridged, large, small, etc. In an embodiment, the plurality of swappable nose bridges 472 may be of different colors or may include other differentiating features (e.g., symbols) that allow a user to know which of the plurality of swappable nose bridges 472 belongs to that user or is a particular size. For example, each user may use their own swappable nose bridge 472 that is differentiated by color, for example, in order to the user to readily swap in their assigned or owned swappable nose bridge 472 to use with the HMD device.

As described herein, the swappable nose bridge 472 may be operatively coupled into a bottom side of the HMD shield housing. As described herein, the HMD shield housing of the HMD device may include a nose bridge slot. This nose bridge slot may receive a nose bridge extension 474 of the swappable nose bridge 472. The nose bridge extension 474 may be sized to fit within the nose bridge slot easily so that the user may exchange one of a plurality of swappable nose bridges 472 with another where, for example, the first user needs to have a swappable nose bridge 472 that is owned by the user or sized to fit the user as described herein. In an embodiment, the nose bridge extension 474 may be sized to create an interference fit within the nose bridge slot. The level of interference fit may be such that the swappable nose bridge 472 snaps in and is not easily separatable from the HMD shield except by the user applying sufficient force to remove the nose bridge extension 474 from within the nose bridge slot.

In an embodiment, the nose bridge extension 474 may include a nose bridge magnet placed at a nose bridge magnet location 480. The nose bridge magnet at the nose bridge magnet location 480 may interface with a metal portion within the nose bridge slot such as a ferromagnetic metal keep. In an embodiment, the ferromagnetic metal keep may be made of a ferromagnetic material that magnetically interacts with the nose bridge magnet at the nose bridge magnet location 480 to help secure the nose bridge extension 474 within the nose bridge slot and, accordingly, the swappable nose bridge 472 to the HMD shield. In an embodiment, the nose bridge magnet at the nose bridge magnet location 480 may be embedded within the nose bridge extension 474. In this embodiment, the material of the swappable nose bridge 472 may conceal the presence of the nose bridge magnet or attached thereto. In an embodiment, the material forming the swappable nose bridge 472 may be a pliable plastic, rubber, silicone, or synthetic rubber that is capable of being injection molded into a mold, for example. In the case where rubber, silicone, or synthetic rubber is used, the surface of the rubber or synthetic rubber may increase the friction between the surfaces of the swappable nose bridge 472 and the user's nose. This may increase the ability of the swappable nose bridge 472 and the HMD device to be retained on the user's face and not move on the user's face while in use.

In an embodiment, the swappable nose bridge 472 may include a nose bridge collar 482. The nose bridge collar 482 may be a portion of the swappable nose bridge 472 that conforms to an outside surface of the HMD shield, the HMD frame, and the face mask. The nose bridge collar 482 may conform to the outside surface of the HMD shield in order to prevent light from entering the area between the HMD video display and the user's eyes thereby creating a lightproof environment. By providing this lightproof environment via the nose bridge collar, the user may better see the images and video presented to the user via the HMD video display. In an embodiment, the nose bridge collar 482 may be formed within the mold used to form the swappable nose bridge 472 as described herein. In an embodiment, the nose bridge collar 482 may abut any portion of the HMD device including a face mask that abuts the user's face when the HMD device is being worn.

In an embodiment, the swappable nose bridge 472 may include a nose bridge slit 484 formed through a portion of the swappable nose bridge 472. The nose bridge slit 484 may be formed along a portion of the swappable nose bridge 472 where a ridge of the user's nose may contact the swappable nose bridge 472. The nose bridge slit 484 may, in an embodiment, create two nose bridge flaps 463 that separate the portion of the swappable nose bridge 472 that contacts the user's nose when the HMD device is being worn. In an embodiment, the nose bridge flaps 463 formed by the nose bridge slit 484 may include a shape memory alloy structure (e.g., sheet, rod, or wire) embedded in the nose bridge flaps 463 to allow a portion of the swappable nose bridge 472 contacting the user's nose to be elastically deformed to conform and adjust to fit to a shape of the user's nose. In FIG. 4, the nose bridge flaps 463 may, therefore, be allowed to move up and down as indicated by the dashed lines. The shape memory alloy structure may be a sheet, rod, or wire of, for example, metal alloys that includes one or more of copper, aluminum, cadmium, nickel, gallium, gold, iron, silicon, beryllium, palladium, zinc, platinum, niobium, hafnium, manganese, cobalt, tin, among other metals and non-metals in different proportions. In an embodiment, any variety of structures of the shape memory alloy may be embedded into the nose bridge flaps 463 on either side of by the nose bridge slit 484. In an embodiment, the shape memory alloy may be embedded into the nose bridge flaps 463 using the injection molding process described herein. In an embodiment, the injection molding process may include inserting the structure (e.g., sheet, rod, or wire) of shape memory alloy into a mold and injecting a pliable silicone, plastic, rubber, or synthetic rubber into the mold and secure the structure of the shape memory alloy into the nose bridge flaps 463. In an embodiment, this injection molding process may be completed concurrently with the injection molding process used to secure the nose bridge magnet at the nose bridge magnet location 480 within the nose bridge extension 474 as described herein. The shape memory alloy structures formed into the nose bridge flaps 463 allows the portions of the swappable nose bridge 472 that touches the user's nose to be elastically deflected or bent into a position (as indicated by dashed lines) to conform or be fitted to the surface of the user's nose. This increases the comfortability of the swappable nose bridge 472 as the HMD device is placed on the user's head.

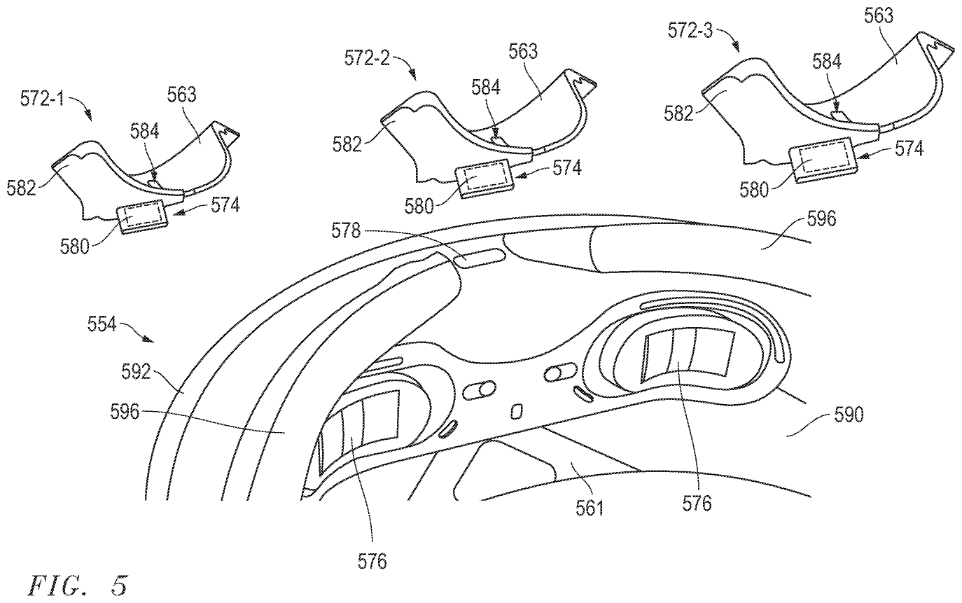

FIG. 5 is a graphic diagram bottom view of an XR HMD device 554 with a plurality of different sized and shaped swappable nose bridge 572-1, 572-2, 572-3 according to another embodiment of the present disclosure. As described herein, the HMD device 554 may include an HMD shroud 590 operatively coupled to the HMD shield 592. Again, because the area between the user's eyes and the HMD video display 576 needs to be dark, the HMD shroud 590 may prevent light from entering this area. In an embodiment, the HMD shroud 590 may be lightproof so that the user may view the images and videos presented to the user at the HMD video display 576. In an embodiment, the HMD shroud 590 may include an HMD frame 561 that maintains a shape of the HMD shroud 590 around the user's eyes and away from the HMD video display 576. In an embodiment, the HMD frame 561 and HMD shroud 590 may include a face mask 596 used to abut a user's face when the HMD device 554 is worn. The face mask 596 may be made of a pliable material such as a foam in order to soften the interface between the HMD device 554 and the user's face making the wearing of the HMD device 554 more comfortable to the user.

The HMD device 554 may include an HMD shield 592 in an embodiment. The HMD shield 592 may act as part of the housing on to which other components of the HMD device 554 may be secured or into which some of the hardware of the HMD device 554 may be placed. For example, the HMD device 554 may include a camera/pass-through camera (not shown) used to provide data to a processing resource describing the location of the HMD device 554 within a physical environment. Additionally, the camera/pass-through camera may provide images to the user via the HMD video display 576 of the physical environment around the user. The camera/pass-through camera may be formed into a front portion of the HMD shield 592 as described in embodiments herein.

The HMD shield 592 may also house an IR detector/IR emitter (not shown). In an embodiment, the IR detector/IR emitter, or visible light versions of the same, for example, within either on the HMD device 554 (e.g., inward-out location detection) or located within the physical environment (e.g., outward-in location detection), may be used to triangulate or multilaterate the location of the HMD device 554 within the physical environment. In the example embodiment shown in FIG. 5, the IR detector/IR emitter may also be placed within the housing of the HMD shield 592 to protect the IR detector/IR emitter 588 from damage.

As described herein, the HMD device 554 includes one or more swappable nose bridge 572-1, 572-2, 572-3. In order to also make the user more comfortable, the HMD device 554 may include these swappable nose bridges 572-1, 572-2, 572-3. The swappable nose bridge 572-1, 572-2, 572-3 may each be a removable part of the HMD housing such as part of the HMD shield 592. The swappable nose bridges 572-1, 572-2, 572-3 contact the user's nose when the HMD device 554 is placed on the user's head. In an embodiment, each of the swappable nose bridges 572-1, 572-2, 572-3 may made available to the user to operatively couple to the HMD shield 592. These plurality of swappable nose bridges 572-1, 572-2, 572-3 may be of different sizes, shapes, or colors to accommodate the user or a plurality of users when interfacing with the HMD device 554. For example, a first user may have a relatively smaller nose than a second user and the plurality of swappable nose bridge 572-1, 572-2, 572-3 may be differentiated by different sizes and shapes to accommodate these differences is physiology between, in this example, the first user and the second user. In an embodiment, the plurality of swappable nose bridge 572-1, 572-2, 572-3 may be of different colors or may include other differentiating features (e.g., symbols) that allow selection of size or for a user to know which of the plurality of swappable nose bridge 572-1, 572-2, 572-3 belongs to that user. For example, a user may select a specific color of swappable nose bridge 572-1, 572-2, 572-3 indicating size or select based on aesthetics and may use this swappable nose bridge 572-1, 572-2, 572-3 during use of the HMD device 554.

As described herein, each of the swappable nose bridges 572-1, 572-2, 572-3 may be operatively coupled into a bottom side of the HMD shield 592. As described herein, the HMD shield 592 of the HMD device 554 may include a nose bridge slot 578. This nose bridge slot 578 may receive a nose bridge extension 574 of each of the swappable nose bridges 572-1, 572-2, 572-3. The nose bridge extensions 574 may be sized to fit within the nose bridge slot 578 easily so that the user may exchange one of a plurality of swappable nose bridges 572-1, 572-2, 572-3 with another where, for example, the first user needs to have one of the swappable nose bridges 572-1, 572-2, 572-3, owned by the user or sized to fit the user as described herein. In an embodiment, the nose bridge extension 574 of each of each of the swappable nose bridges 572-1, 572-2, 572-3 may be sized to create an interference fit within the nose bridge slot 578. The level of interference fit may be such that the swappable nose bridges 572-1, 572-2, 572-3 snap in and are not easily separatable from the HMD shield 592 when inserted into the nose bridge slot 578 except by the user applying force enough to remove the nose bridge extension 574 from within the nose bridge slot 578.

In an embodiment, each of the nose bridge extensions 574 may include a nose bridge magnet placed at a nose bridge magnet location 580. The nose bridge magnet at the nose bridge magnet location 580 may interface with a metal portion within the nose bridge slot 578 such as a ferromagnetic metal keep. The ferromagnetic metal keep may line some portion of the inside of the nose bridge slot 578. In an embodiment, the ferromagnetic metal keep may be made of a ferromagnetic material that magnetically interacts with the nose bridge magnet at the nose bridge magnet location 580 to help secure the nose bridge extension 574 within the nose bridge slot 578 and, accordingly, the swappable nose bridges 572-1, 572-2, 572-3 to the HMD shield 592. In an embodiment, the nose bridge slot 578 may have a magnet formed therein to be magnetically coupled to the nose bridge magnet at the nose bridge magnet location 580. The magnet formed within or near the nose bridge slot 578 may be of opposite polarity to a magnet embedded in or mounted to the nose bridge extension 574 in embodiments herein.

In an embodiment, the nose bridge magnets at the nose bridge magnet locations 580 may be embedded within the nose bridge extensions 574 or operably coupled thereto by adhesive, a fastener, or other attachment device in some embodiments. In this embodiment, the material of each of the swappable nose bridges 572-1, 572-2, 572-3 may conceal the presence of the nose bridge magnet. In an embodiment, the swappable nose bridges 572-1, 572-2, 572-3 may be manufactured by placing a nose bridge magnet within a mold and the material forming the swappable nose bridges 572-1, 572-2, 572-3 may be injection molded into the mold to secure the nose bridge magnet at the nose bridge magnet location 580 within the nose bridge extension 574. In an embodiment, the material forming the swappable nose bridges 572-1, 572-2, 572-3 may be a pliable plastic, rubber, silicone, or synthetic rubber that is capable of being injection molded into a mold, for example. In the case where rubber, silicone, or synthetic rubber is used, the surface of the rubber, silicone, or synthetic rubber may increase the friction between the surfaces of the swappable nose bridges 572-1, 572-2, 572-3 and the users' nose. This may increase the ability of the swappable nose bridges 572-1, 572-2, 572-3 and the HMD device 554 to be retained on the user's face and not move on the user's face while in use.

In an embodiment, each of the swappable nose bridges 572-1, 572-2, 572-3 may include a nose bridge collar 582. The nose bridge collar 582 may be a portion of each of the swappable nose bridges 572-1, 572-2, 572-3 that conforms to an outside surface of the HMD shield 592, the HMD frame 561, or the face mask 596. The nose bridge collar 582 may conform to the outside surface of the HMD shield 592 in order to prevent light from entering the area between the HMD video display 576 and the user's eyes thereby creating a lightproof environment. By providing this lightproof environment via the nose bridge collar 582, the user may better see the images and video presented to the user via the HMD video display 576. In an embodiment, the nose bridge collar 582 may be formed within the mold used to form the swappable nose bridges 572-1, 572-2, 572-3 as described herein. In an embodiment, the nose bridge collar 582 may abut any portion of the HMD device 554 including a face mask 596 that abuts the user's face when the HMD device 554 is being worn.

In an embodiment, each of the swappable nose bridges 572-1, 572-2, 572-3 may include a nose bridge slit 584 formed through a portion of each of the swappable nose bridges 572-1, 572-2, 572-3. The nose bridge slit 584 may be formed along a portion of each of the swappable nose bridges 572-1, 572-2, 572-3 where a ridge of the user's nose may contact the swappable nose bridge 572, in an embodiment. It is appreciated, however, that one or more nose bridge slits 584 may be formed through each of the swappable nose bridges 572-1, 572-2, 572-3 creating more nose bridge flaps 563 than shown in FIG. 5. The nose bridge slit 584 may, in an embodiment, create two nose bridge flaps 563 that separate the portion of each of the swappable nose bridges 572-1, 572-2, 572-3 that contacts the user's nose when the HMD device 554 is being worn. In an embodiment, the swappable nose bridges 572-1, 572-2, 572-3 made be made using an injection molding process. This process may include forming a mold and injection molding the swappable nose bridges 572-1, 572-2, 572-3 as described herein. The injection molding process may or may not include the insertion of the nose bridge magnet and/or shape memory alloy structures into the mold prior to injection of the rubber, silicone, synthetic rubber, or plastic.

In one embodiment, the nose bridge flaps 563 formed by the nose bridge slit 584 may include a shape memory alloy structure embedded in the nose bridge flaps 563 to allow a portion of each of the swappable nose bridges 572-1, 572-2, 572-3 contacting the user's nose to be elastically deformed to conform and fit to a shape of the user's nose. This shape memory alloy structure may be made of, for example, metal alloys that includes one or more of copper, aluminum, cadmium, nickel, gallium, gold, iron, silicon, beryllium, palladium, zinc, platinum, niobium, hafnium, manganese, cobalt, tin, among other metals and non-metals in different proportions. In an embodiment, a sheet, rod, or wire of the shape memory alloy may be embedded into the nose bridge flaps 563 created by the nose bridge slit. In an embodiment, the shape memory alloy structure may be embedded into the nose bridge flaps 563 using the injection molding process described herein. In an embodiment, the injection molding process may include inserting the sheet or sheets of shape memory alloy into a mold and injecting a pliable plastic, silicone, rubber, or synthetic rubber into the mold and secure the sheet or sheets of shape memory alloy into the nose bridge flaps 563. In an embodiment, this injection molding process may be completed concurrently with the injection molding process used to secure the nose bridge magnet at the nose bridge magnet location 580 within the nose bridge extension 574 as described herein. The shape memory alloy structure formed into the nose bridge flaps 563 allows the portions of the swappable nose bridge 572 that touches the user's nose to be elastically deflected and bent into a position to conform to the surface of the user's nose. This increases the comfortability and adjustability of the swappable nose bridges 572 as the HMD device 554 is placed on the user's head.

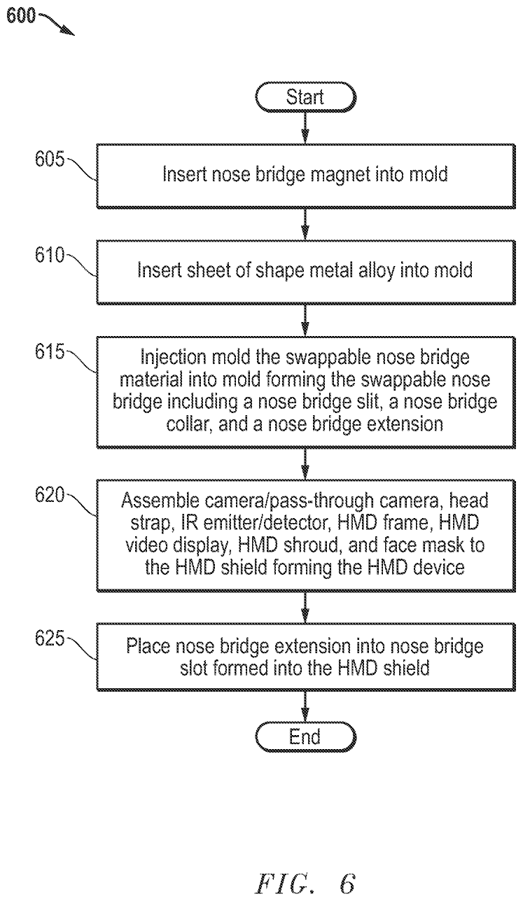

FIG. 6 is a flow diagram illustrating a method 600 of manufacturing an HMD device with a swappable nose bridge according to an embodiment of the present disclosure. The method 600 may include the manufacture of the swappable nose bridge described in embodiments herein as well as assembly of the swappable nose bridge to the HMD housing of the HMD device described herein.

The method 600 may include, at block 605, with inserting a nose bridge magnet into a mold. The mold described herein is used for the injection molding of the swappable nose bridges described herein. As such, because the nose bridge magnet is to be placed within the nose bridge extension, the nose bridge magnet may be placed in the mold at a location where the nose bridge extension will be formed within the mold.

At block 610, the method 600 may optionally include the placement of shape metal alloy structure (e.g., rods, sheets, or wires) into this mold as well. As described herein, the shape metal alloy sheets may be used to allow for the nose bridge flaps to be elastically bendable into position when the HMD device is being worn by the user. Because these sheets of shape metal alloy are to be formed into (e.g., embedded into) the nose bridge flaps, the sheets of shape metal alloy may be placed within the mold in a location where the nose bridge flaps will be formed during the injection molding process.

The method 600 further includes injection molding the swappable nose bridge by injecting, into the mold, a material used to form the swappable nose bridge. This material may include a bendable or pliable silicone, plastic, a rubber, or a synthetic rubber among other types of materials. By injection molding the swappable nose bridge at block 615, the nose bridge slit, nose bridge collar, and nose bridge extension may each be formed as described herein. In another example embodiment, the injection molding process may include a plurality of injection molding processes that includes removing an incomplete swappable nose bridge from a first mold, placing the incomplete swappable nose bridge into a second mold, and conducting a second injection molding process. This may be beneficial where, for example, the nose bridge magnet and sheets of shape metal alloy are to be individually added to a mold separately.

At block 620 the method 600 includes the construction of the HMD device worn by the user. This process at block 620 may include assembling a camera/pass-through camera, head strap, IR emitter/detector, HMD frame, HMD shroud, HMD video display, and face mask to the HMD shield thereby forming the HMD device. These processes may include the operative coupling of the IR emitter/detector, the camera/pass-through camera, and HMD video display to, for example, a printed circuit board (PCB) within the HMD shroud so that these devices may be operatively coupled, via PCB circuitry, to the HMD connection wire described in connection with FIG. 2 and to other processing, power, and data storage resources as described herein.

Further, at block 620, the nose bridge slot may be formed into the housing of the HMD device such as at the HMD shield. In an embodiment, a metal portion within the nose bridge slot such as a ferromagnetic metal keep may be formed the inside surface of some or all of the nose bridge slot to interface with the nose bridge magnet. In another embodiment, a magnet of opposite polarity to one on a nose bridge extension may be embedded or mounted in the housing of the HMD device at the nose bridge slot or mounted inside the nose bridge slot in some embodiments. In another embodiment, the nose bridge extension and nose bridge slot may be sized to create an interference fit between them when the nose bridge extension is coupled into the nose bridge slot. The level of interference fit may be such that the swappable nose bridge snaps in and is not easily separatable from the HMD shield except by the user applying sufficient force to remove the nose bridge extension from within the nose bridge slot in an embodiment. In some embodiments, either an embedded magnet or magnets/metallic keep or an interference fit may be formed for use to operatively couple the nose bridge extension to the nose bridge slot.

The method 600 may also include, at block 625, with placing the nose bridge extension into the nose bridge slot formed into the HMD shield. This process may be completed by a factory worker in an embodiment. In another embodiment, this process may be completed by an end user where, for example, the user is provided with an option to switch out and use multiple swappable nose bridges that are provided to the user at the time of purchase. Once assembled, the method 600 may end. In an embodiment, placing the nose bridge extension into the nose bridge slot formed into the HMD shield creates a magnetic attraction between the nose bridge magnet at the nose bridge extension and the metal keep or internal magnet in various embodiments described herein. Alternatively, or additionally, an interference fit may be made between the nose bridge extension and the nose bridge slot. Again, the level of interference fit may be such that the swappable nose bridge snaps in and is not easily separatable from the HMD shield except by the user applying sufficient force to remove the nose bridge extension from within the nose bridge slot in an embodiment.

The blocks of the flow diagrams of FIG. 6 or steps and aspects of the operation of the embodiments herein and discussed above need not be performed in any given or specified order. It is contemplated that additional blocks, steps, or functions may be added, some blocks, steps or functions may not be performed, blocks, steps, or functions may occur contemporaneously, and blocks, steps or functions from one flow diagram may be performed within another flow diagram.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An extended reality (XR) head-mounted display (HMD) device comprising:
a processor;
a memory device;
a power management unit;
an HMD video display to present to a user an extended reality image of an environment;
an HMD housing fitted to be formed around a user's eyes; and
a swappable nose bridge, including:
a nose bridge extension to fit within a nose bridge slot formed into the HMD housing; and
a nose bridge magnet formed at the nose bridge extension to magnetically engage within the nose bridge slot formed in the HMD housing.

2. The XR HMD device of claim 1, wherein the nose bridge extension is sized to create an interference fit within the nose bridge slot.

3. The XR HMD device of claim 1 further comprising:
a nose bridge collar formed on the swappable nose bridge to conform to a surface of the HMD housing to be lightproof within the HMD housing.

4. The XR HMD device of claim 1, further comprising:
one or more nose bridge slits formed into the nose bridge where the user's nose is to rest, the one or more nose bridge slits forming nose bridge flaps to conform to a surface of the user's nose.

5. The XR HMD device of claim 1, further comprising:
the nose bridge slot including a metal keep to magnetically engage with the nose bridge magnet.

6. The XR HMD device of claim 1 further comprising:
the nose bridge slot including a slot magnet formed into the nose bridge slot, the slot magnet to magnetically engage with the nose bridge magnet.

7. The XR HMD device of claim 1, wherein the nose bridge is injection molded around the nose bridge magnet with the nose bridge magnet being embedded into the nose bridge at the nose bridge extension.

8. The XR HMD device of claim 1, further comprising:
a shape memory alloy structure embedded in the nose bridge to allow a portion of the nose bridge contacting the user's nose to be elastically deformed into a position to conform to a shape of the user's nose.

9. A swappable nose bridge of an extended reality (XR) head mounted display (HMD) device comprising:
a nose bridge extension to fit within a nose bridge slot formed into an HMD housing of the HMD device;
a nose bridge magnet formed at the nose bridge extension to magnetically engage within the nose bridge slot;
a nose bridge collar formed on the nose bridge to conform to a surface of the HMD housing to be lightproof within the HMD housing; and
a nose bridge flaps sized to rest on a user's nose.

10. The swappable nose bridge of claim 9, wherein the nose bridge extension is sized to create an interference fit within the nose bridge slot.

11. The swappable nose bridge of claim 10 further comprising:
a nose bridge slit formed into the nose bridge where the user's nose is to rest, the nose bridge slit forming plural nose bridge flaps to conform to a surface of the user's nose.

12. The swappable nose bridge of claim 10, wherein the nose bridge magnet magnetically engages with a metal keep within the nose bridge slot in the HMD housing.

13. The swappable nose bridge of claim 9 further comprising:
the nose bridge magnet to magnetically engage with a slot magnet formed into the nose bridge slot of the HMD housing, the slot magnet having an opposite polarity to the nose bridge magnet.

14. The swappable nose bridge of claim 9, wherein the nose bridge is injection molded with a silicone material such that the nose bridge magnet is embedded into the nose bridge at the nose bridge extension.

15. The swappable nose bridge of claim 9 further comprising:
a shape memory alloy structure embedded in the nose bridge to allow a portion of the nose bridge contacting the user's nose to be elastically deformed into a position to conform to a shape of the user's nose.

16. An extended reality (XR) head-mounted display (HMD) device comprising:
a processor;
a memory device;
a power management unit;
an HMD video display to present to a user an extended reality image of an environment;
an HMD housing fitted to be formed around a user's eyes, the HMD housing including a nose bridge slot to operatively couple one of a plurality of swappable nose bridges to the HMD housing; and
a plurality of different sized swappable nose bridges, each swappable nose bridge including:
a nose bridge extension to fit within the nose bridge slot formed into the HMD housing, wherein the nose bridge extension of each of the plurality of different sized swappable nose bridges is sized to create an interference fit within the nose bridge slot.

17. The XR HMD device of claim 16 further comprising:
a nose bridge magnet formed at the nose bridge extension to magnetically engage within the nose bridge slot formed in the HMD housing.

18. The XR HMD device of claim 16, further comprising:
a nose bridge collar formed on each of the plurality of different sized swappable nose bridges to conform to a surface of the HMD housing to be lightproof within the HMD housing.

19. The XR HMD device of claim 16, further comprising:
one or more nose bridge slits formed into each of the plurality of different sized swappable nose bridges where the user's nose is to rest, the one or more nose bridge slits forming nose bridge flaps to conform to a surface of the user's nose.

20. The XR HMD device of claim 16, further comprising:
a shape memory alloy structure embedded in each of the plurality of different sized swappable nose bridges to allow a portion of each of the plurality of different sized swappable nose bridges contacting the user's nose to be elastically deformed into a position to conform to a shape of the user's nose.
